(19) United States
(12) Patent Application Publication
(10) Pub. No.: US 2023/0301280 A1
(43) Pub. Date: Sep. 28, 2023

(54) AUTONOMOUS REAL-TIME FEED OPTIMIZATION AND BIOMASS ESTIMATION IN AQUACULTURE SYSTEMS

(71) Applicant: Forever Oceans Corporation, Bethesda, MD (US)

(72) Inventors: Vineeth Aljapur, Kailua-Kona, HI (US); Mathew Goldsborough, Kamuela, HI (US); Justin Pham, Kailua-Kona, HI (US); Anthony White, Kailua-Kona, HI (US)

(21) Appl. No.: 18/131,769

(22) Filed: Apr. 6, 2023

Related U.S. Application Data
(63) Continuation of application No. PCT/US2021/053749, filed on Oct. 6, 2021.
(60) Provisional application No. 63/088,611, filed on Oct. 7, 2020.

(51) Int. Cl. A01K 61/80; G06T 7/13

(52) U.S. Cl. CPC A01K 61/80; G06T 7/13; G06T 2207/10016; G06T 2207/20081

(57) ABSTRACT

The subject matter of this disclosure relates to a system and a method for biomass detection and feed control in an aquaculture environment. An example computer-implemented method includes: providing a feed supply for an aquaculture cage containing a plurality of fish; obtaining data derived from one or more sensors disposed on or within the aquaculture cage; using one or more machine learning models that receive the data as input and provide as output a determination of at least one of a fish biomass, a fish biomass distribution, or a fish satiation level for the aquaculture cage; and based on the determination from the one or more machine learning models, controlling an amount of feed delivered to the aquaculture cage from the feed supply.

### CROSS-REFERENCE TO RELATED APPLICATION

This application claims the benefit of U.S. Provisional Pat. pplication No. 63/088,611, filed Oct. 7, 2020, the disclosure of which is hereby incorporated by reference herein in its entirety.

### TECHNICAL FIELD

Embodiments of this disclosure relate to the use of machine learning and/or artificial intelligence and, more specifically, to the use of computer vision for real-time fish-feed control and continuous biomass measurement in aquaculture systems.

### BACKGROUND

Two of the most difficult, dangerous, and cost intensive tasks for an aquaculture system are feeding fish and estimating fish biomass. Typically, this can require teams to make daily trips to offshore pens or cages containing the fish. For estimation of biomass, scuba divers can go into cages of the aquafarm to take samples of live fish for measurement. This exposes the divers to risks, causes stress to fish, and sacrifices a portion of fish that will not go to harvest. Additionally, the number of fish sampled is considerably less than the total number in the pen, such that statistical estimates of the overall fish population biomass distribution can contain inherent uncertainties. Even when fairly close to shore (e.g., less than 5 nm), divers may spend upwards of two hours of idle time per day traveling back and forth to an offshore aquafarm.

Traditional solutions for feeding can involve manual and video-assisted feeding through the use of manually operated feeding equipment. Operators in this paradigm may be required to be physically near equipment and/or computers, so that feed levels and signs of overfeeding can be monitored. This can add to risks associated with losses in video signals and human errors, which can result in valuable time or materials lost during feeding. For example, subtle behavioral changes like satiation can be difficult to detect with the naked eye, a failure to detect such changes can result in losses of significant quantities of feed. Such losses or inefficient feeds can negatively impact a Feed Conversion Ratio (FCR) for an aquafarm, thereby increasing what is already the number one cost associated with raising the fish. As commercial aquafarms increase in distance from shore and the sizes of the cages increase, inefficiencies in this conventional model can significantly reduce the profitability of aquafarms.

There is a pressing need to automate feeding and biomass estimation (e.g., using machine leaming and artificial intelligence) for the purpose of reducing operational risks and increasing the profitability of aquaculture farms.

The foregoing discussion, including the description of motivations for some embodiments of the invention, is intended to assist the reader in understanding the present disclosure, is not admitted to be prior art, and does not in any way limit the scope of any of the claims.

### SUMMARY OF THE INVENTION

In one aspect, the subject matter of this disclosure relates to a system for biomass detection and feed control in an aquaculture environment. The system includes: an aquaculture cage containing a plurality of fish; a feed supply for the aquaculture cage; one or more sensors disposed on or within the aquaculture cage; and one or more computer processors programmed to perform operations including: obtaining data derived from the one or more sensors; using one or more machine learning models that receive the data as input and provide as output a determination of at least one of a fish biomass, a fish biomass distribution, or a fish satiation level for the aquaculture cage; and based on the determination from the one or more machine learning models, controlling an amount of feed delivered to the aquaculture cage from the feed supply.

In certain examples, the feed supply is located on a supply vessel in communication with the aquaculture cage. The one or more sensors can be disposed on corners of the aquaculture cage, opposite ends of the aquaculture cage, and/or walls of the aquaculture cage. The one or more sensors can include a camera, a proximity sensor, a depth sensor, a scanning sonar sensor, a laser, a light emitting device, a microphone, a remote sensing device, or any combination thereof. The data can include stereo vision data, image data, video data, proximity data, depth data, sound data, sonar data, or any combination thereof. At least one computer processor from the one or more computer processors can be located on a supply vessel in communication with the at least one aquaculture cage.

In some implementations, the one or more machine leaming models can be trained to recognize fish poses and to identify images of fish in desired poses, and the one or more machine learning models can be configured to output the determination based on at least one of the identified images. The one or more machine learning models can be trained to determine the fish biomass or the fish biomass distribution based on a fish size and/or a number of fish in the aquaculture cage. The one or more machine learning models can be trained to determine the fish satiation level based on fish behavior data, and the fish behavior data can include fish velocity and/or fish acceleration. Controlling the amount of feed delivered to the aquaculture cage from the feed supply can include adjusting a feed rate and/or a feed frequency.

In another aspect, the subject matter of this disclosure relates to a computer-implemented method. The method includes: providing a feed supply for an aquaculture cage containing a plurality of fish; obtaining data derived from one or more sensors disposed on or within the aquaculture cage; using one or more machine leaming models that receive the data as input and provide as output a determination of at least one of a fish biomass, a fish biomass distribution, or a fish satiation level for the aquaculture cage; and based on the determination from the one or more machine learning models, controlling an amount of feed delivered to the aquaculture cage from the feed supply.

In some examples, the feed supply is located on a supply vessel in communication with the aquaculture cage. The one or more sensors can be disposed on corners of the aquaculture cage, opposite ends of the aquaculture cage, and/or walls of the aquaculture cage. The one or more sensors can include a camera, a proximity sensor, a depth sensor, a scanning sonar sensor, a laser, a light emitting device, a microphone, a remote sensing device, or any combination thereof. The data can include stereo vision data, image data, video data, proximity data, depth data, sound data, sonar data, or any combination thereof. At least one computer processor from the one or more computer processors can be located on a supply vessel in communication with the at least one aquaculture cage.

In various implementations, the one or more machine learning models can be trained to recognize fish poses and to identify images of fish in desired poses, and the one or more machine learning models can be configured to output the determination based on at least one of the identified images. The one or more machine learning models can be trained to determine the fish biomass or the fish biomass distribution based on a fish size and/or a number of fish in the aquaculture cage. The one or more machine learning models can be trained to determine the fish satiation level based on fish behavior data, and the fish behavior data can include fish velocity and/or fish acceleration. Controlling the amount of feed delivered to the aquaculture cage from the feed supply can include adjusting a feed rate and/or a feed frequency.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. For proper understanding of the invention, reference should be made to the accompanying drawings, wherein:

FIG. 1 includes a schematic profile view of an embodiment of a system for data collection inside a submerged aquaculture cage environment;

FIG. 2 includes a schematic diagram of a high-level system architecture in which multiple aquafarms are accessible to operator(s) or external actor(s);

FIG. 3 includes a schematic diagram of an embodiment of an aquafarm utilizing video streams and edge computing for feed optimization;

FIG. 4 includes a schematic diagram of an embodiment of an aquafarm utilizing video streams and edge computing for biomass estimation;

FIG. 5 includes a flowchart of a method of controlling a feed supply for an aquaculture environment, in accordance with certain examples; and

FIG. 6 includes a schematic block diagram of an example computer system.

As will be readily described and illustrated in the figures herein, the invention may be arranged and designed in a wide variety of different configurations. Thus, the following detailed description of the embodiments of autonomous real-time feed optimization and biomass estimation in aquaculture systems, as represented in the attached figures, is not intended to limit the scope of the invention, but is merely representative of selected embodiments of the invention.

### DETAILED DESCRIPTION

The features, structures, or characteristics of the invention described throughout this specification may be combined in any suitable manner in one or more embodiments. For example, the usage of the phrases “certain embodiments,” “some embodiments,” “various examples,” or other similar language, throughout this specification refers to the fact that a particular feature, structure, or characteristic described in connection with the embodiment may be included in at least one embodiment of the present invention. Thus, appearances of the phrases “in certain embodiments,” “in some embodiments,” “in other embodiments,” “in certain examples,” “in some implementations,” or other similar language, throughout this specification do not necessarily all refer to the same group of embodiments, and the described features, structures, or characteristics may be combined in any suitable manner in one or more embodiments.

Additionally, if desired, the different configurations and functions discussed below may be performed in a different order and/or concurrently with each other. Furthermore, if desired, one or more of the described configurations or functions may be optional or may be combined. As such, the following description should be considered as merely illustrative of the principles, teachings and embodiments of this invention, and not in limitation thereof.

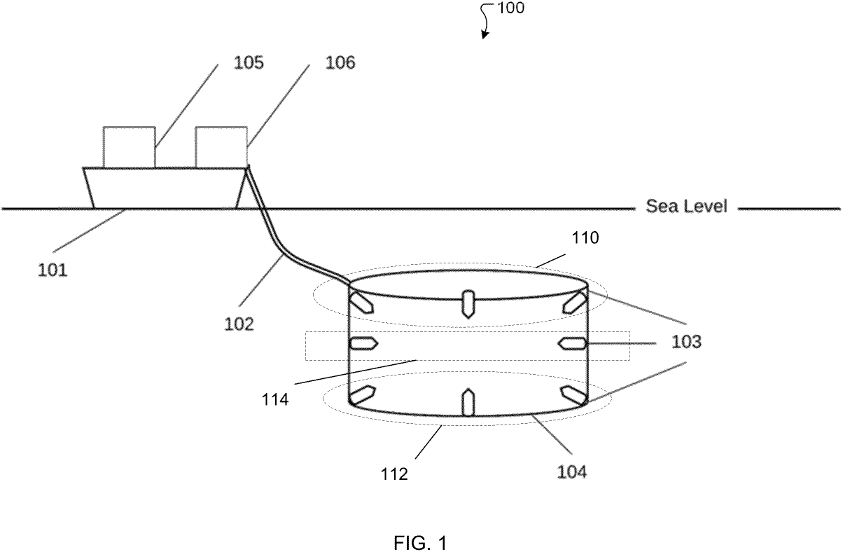

FIG. 1 illustrates an embodiment of a system 100 that includes an aquaculture cage 104 attached to a supply vessel 101. The cage 104 can be substantially cylindrical in shape, though other shapes can be used, such as, for example, cubical, spherical, and/or polygonal. The cage 104 can be fully submerged or partially submerged in a body of water, such as an ocean, sea, or lake. Power and communications for the system 100 may come from the supply vessel 101 via a tether 102 to the cage 104. The tether 102 can be or include one or more communication lines, wires, and/or cables.

Stereo vision and/or other sensing capabilities can be achieved through the use of cameras and/or other sensors 103 (e.g., including proximity sensors, depth sensors, scanning sonar sensors, a laser, a light emitting device, a microphone, and/or a remote sensing device) placed at strategic location(s) in or around the cage 104. In some embodiments, the cameras and/or sensors 103 can be configured to collect and/or transmit image data, video data, proximity data, depth data, sound data, sonar data, a laser-based and/or light-based detection data, and/or any other type of remote sensing data. Any number of cameras and/or other sensors 103 can be used (e.g., 1, 5, 10, 20, 40, or more). The cameras and/or sensors 103 can be placed, for example, in corners of the cage 104 and/or along vertical or horizontal walls of the cage 104, as shown. In some examples, the cameras and/or sensors 103 can be placed adjacent to one another along the cage 104 and/or on opposite ends of the cage 104, e.g., as shown. In some implementations, the cameras and/or sensors 103 can be located in an upper portion 110 of the cage 104, a lower portion 112 of the cage 104, and/or a middle portion 114 of the cage 104. In some embodiments, the placement of the cameras and/or sensors 103 can be tuned and/or calibrated for optimal input and/or use with machine learning models (e.g., described in further detail below).

A video and/or data stream (e.g., including images) from the cameras and/or other sensors 103 can be transmitted to one or more edge computers 105 (e.g., on the supply vessel 101), which may communicate with feeding equipment 106 to control feed delivery into the cage 104 (e.g., from a feed supply on the supply vessel 101). In some embodiments, the data stream can include proximity data, depth data, sound data, sonar data, laser-based and/or light-based detection data, and/or any other type of remote sensing data. Communications between the edge computers 105 and the feeding equipment 106 can be done directly through standardized protocols, such as Transmissions Control Protocol (TCP), or indirectly through an electromechanical device that supports TCP. Alternatively or additionally, communications between the edge computers 105 and the feeding equipment 106 can utilize wireless protocols, such as Wi-Fi, BLUETOOTH, ZIGBEE, 3G, 4G, and/or 5G. Controlling feed delivery into the cage 104 can involve determining and/or dispensing an optimal and/or desired amount of feed to fish or other animals within the cage 104.

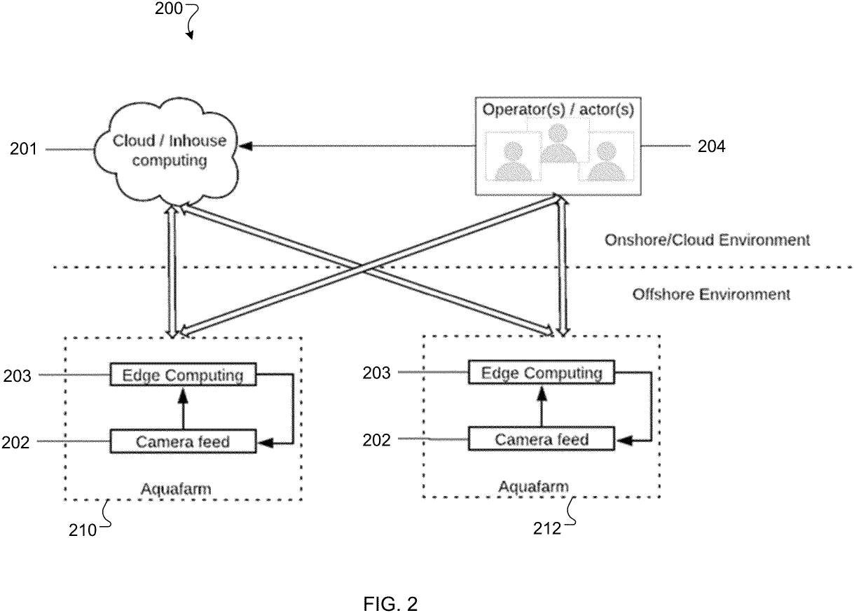

FIG. 2 illustrates a high-level architecture embodiment of a system 200 for multiple aquafarms (including at least aquafarm 210 and aquafarm 212) and external actor(s) 204 that may interact with the aquafarms, such as aquafarm owners or operators. Each aquafarm may have cameras, stereo-enabled sensors, and/or other sensor devices 202 that transmit images and/or video streams (or other data) to an on-board edge computing device 203 capable of performing large-scale computing operations in a relatively small enclosure. The edge computing device 203 can run one or more machine leaming models, as described herein, which can be pre-installed on the device 203 or can be transferred to and/or modified on the device 203, for example, by establishing a connection to in-house computing or a cloud network 201. Each edge computing device 203 can operate completely independent of human control. Alternatively or additionally, results derived from the machine learning models and/or aquafarm operations can be viewed by authorized operators and/or external actors onshore 204 who can, if needed, take control of the system 200 and/or provide corrective action (e.g., to override erroneous model predictions). During normal operations, the machine learning models are capable of adapting and leaming how best to control the system 200 and each aquafarm. For example, the models can learn to optimize feed levels based on camera or sensor input and possibly through guidance provided by the operators 204. The models can be continually and/or periodically re-trained using training data obtained from the sensor devices 202, such as, for example, image data, video data, and/or parameters derived from the image data and/or video data. Additionally or alternatively, the training data can be obtained from or associated with husbandry equipment used to care for and/or collect fish or other animals in the aquafarms. Such training data can include, for example, feed data (e.g., feed amounts, feed rates, and/or feed frequencies), harvest data (e.g., harvest amounts, harvest rates, and/or harvest frequencies), and/or mortality data (e.g., a number of dead fish and/or a mortality rate). In some examples, the machine leaming models are robust enough to adapt to new or modified features or input parameters provided by authorized external actor(s), for example, to improve performance in different lighting and/or environmental conditions (e.g., murky water), or with different fish species.

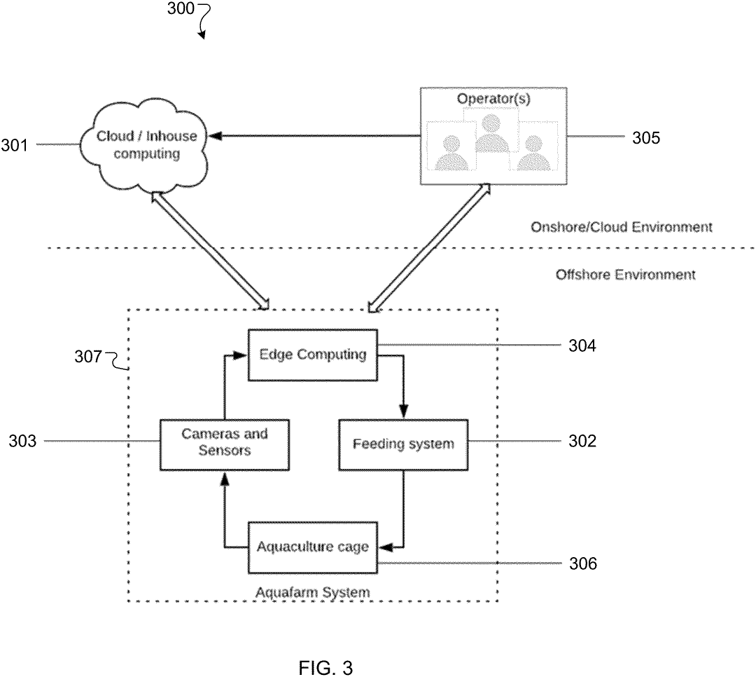

FIG. 3 illustrates an embodiment of a system 300 for achieving real-time, automated feeding in an aquaculture cage 306 for an offshore aquafarm 307. Feeding equipment 302 (e.g., feed bins, conveyors, and/or dispensers) may be connected to a cloud system 301 (or other network) and/or can be located on a supply vessel or in proximity to the cage 306. One or more operators 305 (e.g., located onshore) can use the network to remotely supervise, monitor, and/or control feeding operations, as needed. The system 300 may include or utilize video cameras and/or stereoscopic camera sensors 303 that provide images, video streams, and/or other data (e.g., in a data stream) to an edge computing device 304.

In certain examples, the edge computing device 304 can run one or more machine learning models (e.g., pre-installed on the device 304) that are configured to process data received or derived from the sensors 303. The machine learning models can be used for a variety of purposes, including feed recognition, feed control, and/or monitoring or controlling husbandry functions, such as feeding fish, harvesting fish, and/or removing dead fish or other mortalities from the cage 306. Altematively or additionally, the machine learning models can be updated or refined as needed, for example, by establishing a connection to the network or cloud system 301. The machine leaming models can provide a score that can be used for active feeding and/or to determine appropriate feed levels. In some examples, the machine learning models can be used to keep track of satiation and/or to monitor subtle changes in feeding behavior that might be missed by human operators 305, as described herein. Once the machine leaming models determine that a desired satiation level has been reached, the system 300 can automatically trigger or provide a signal to the feeding equipment 302 to end a feeding session. If needed, authorized operators can update a threshold value above or below which the computing device 304 can signal the feeding equipment 302 to end the feeding. Alternatively or additionally, the operators 305 can end a feeding session manually and/or can override feed determinations made by the device 304 or the machine learning models. In various examples, the predictive models can be refined or trained to accommodate feed operations in a variety of locations or under a variety of conditions (e.g., dependent on water clarity, time of day, time of year, fish species, etc.).

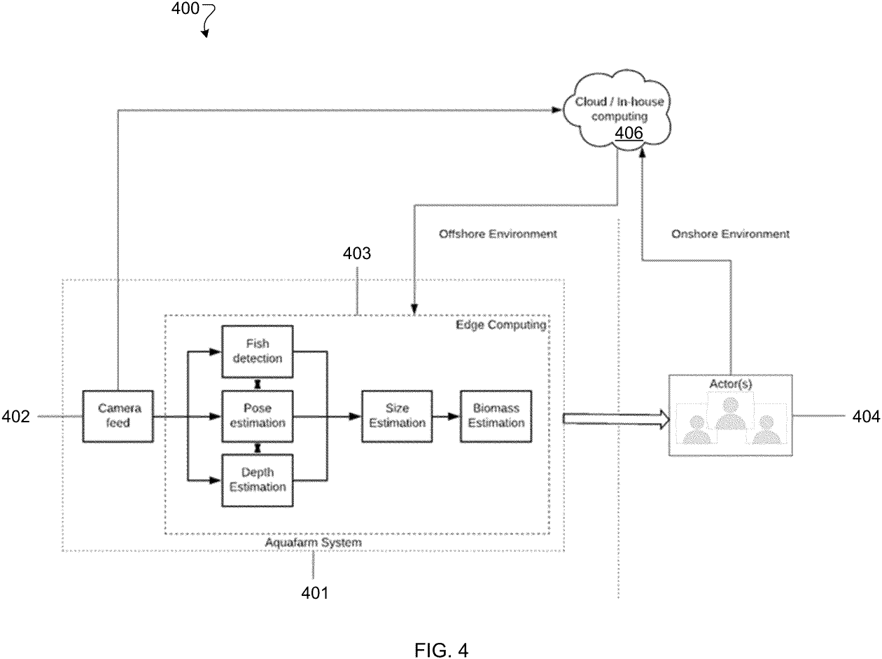

FIG. 4 illustrates an embodiment of a system 400 for estimating an overall biomass and population size distribution in an aquaculture farm, in real-time. The system 400 includes video cameras and/or stereoscopic sensors 402 installed in an aquafarm 401 located in an offshore environment. Images, video, and/or other information from the sensors 402 can be fed to on-board edge computing devices 403 which can operate one or more machine learning models for obtaining biomass estimations. Alternatively or additionally, the machine leaming models can be updated, as needed, through training with additional training data and/or by establishing a connection to an in-house or cloud system 406, as described herein. The machine leaming models can be trained to perform various tasks, based on information obtained from the sensors 402, including for example: fish detection, estimation of fish orientation from pose, and/or identification of a corresponding depth (e.g., a distance between a fish and a camera or sensor 402). These tasks need not be necessarily done in the same order and/or can be used to determine the sizes of fish in individual snapshots in the sensor data. Fish size estimation can be averaged for all or multiple frames (e.g., images) or combinations of frames to determine the sizes of multiple fish in different time intervals. In general, the biomass of a fish species can be a function of physical size and/or shape, and the relationship between biomass and size or shape can be used by the edge computing devices 403, machine learning models, and/or external actors 404 (e.g., onshore) to estimate overall biomass and/or a population biomass distribution for the aquafarm 401. By monitoring the biomass or size distribution curve, operators can tune aspects of the system 400 to optimize an overall growth of a cohort of fish, for example, to ensure that the standard deviation in size is minimized and/or the average biomass is tracked. In some implementations, for example, the overall biomass or biomass distribution for the aquafarm 401 can be used to determine or control an amount of feed provided to fish in the aquafarm (e.g., in a single feeding session). This can involve adjusting or controlling one or more feed parameters, such as an amount of food provided during a feed session, a rate at which food is provided over a period of time, and/or a frequency at which the fish are fed (e.g., a number of feed sessions per day or week). Determining desired or optimal feed amounts and/or feed frequencies can ensure the fish receive a proper amount of food for good growth and health, and can ensure there is little or no excess food that is delivered to the fish but escapes the aquafarm or otherwise goes to waste.

In various implementations, the computing devices and machine leaming models can determine biomass of a fish or other animal based on images, videos, or other data obtained from cameras or other sensors. In some instances, for example, the machine learning models can be trained to recognize certain desired frames or images of fish in a video feed. Such desired images can be or include, for example, a side view and/or a front view of a fish, preferably in a relaxed or straight state or pose (e.g., without a flexed or curved tail). This can be done, for example, by comparing an expected shape or profile for the fish in a straight pose with images collected by the cameras or other sensors. An image of a fish that matches the expected shape can be identified as a desired image and can be used for further processing (e.g., for fish size or satiation measurements). In some instances, image recognition techniques (e.g., using neural networks) can be used to identify the desired images. Additionally or altematively, the machine learning models and/or other system components (e.g., a computing device) can determine a distance or depth of the fish (e.g., from a camera or other sensor). The depth can be determined, for example, using a depth sensor, which may include or utilize multiple cameras (e.g., using a triangulation technique), reference markers inside or near an aquaculture cage, and/or a laser projector. Based on the desired images and/or the determined distance, the machine leaming models or other system components can estimate a size of the fish, for example, a fish weight, length, height, and/or thickness. Multiple fish in the aquafarm 401 can be measured in this manner. Additionally or alternatively, the fish size can be determined based on a shape of the fish, which can depend on a species of the fish.

Additionally or alternatively, in some examples, the machine learning models and/or other components of the system 400 can be trained to determine a number of fish within an aquaculture cage of the aquafarm 401. The number of fish can be determined, for example, based on video, image frames, images, or other data obtained from one or more sensors. For example, the machine learning models can be used to count the number of fish seen in images of the aquaculture cage. By determining the number of fish seen in one or more portions of the cage, a fish population can be extrapolated, as needed, to obtain a total fish population for the entire cage. In some instances, a total biomass (e.g., in pounds or kilograms) for the cage can be determined based on the fish population and determined fish size.

Additionally or alternatively, in some examples, the machine learning models and/or other system components can be trained to monitor fish behavior to determine a level of satiation or health of the fish. For example, when fish are hungry they tend to respond more aggressively or quickly when feed is introduced to an aquaculture cage. Such responses can be detected using cameras or other sensors, for example, to calculate fish velocities, accelerations, or other movements. Such information can be used to determine when feeding sessions should be initiated, continued, or terminated. For example, when feed is being added to the cage and the machine learning models or other system components determine that the fish are not moving in an effort to collect the feed, a decision can be made to terminate the feeding session. Such decisions can be made automatically, with little or no human intervention. In general, the machine leaming models can receive information related to fish behavior as input (e.g., fish velocity or fish acceleration, for individual fish or multiple fish) and can provide as output a determination of fish satiation and/or health (e.g., for individual fish or multiple fish). Data related to these inputs and outputs can be used to train the machine learning models.

In various examples, the machine leaming models described herein can be or include a trained classifier or a regression model or equation. For example, a machine learning model can be or include a classifier such as, for example, one or more linear classifiers (e.g., Fisher’s linear discriminant, logistic regression, Naive Bayes classifier, and/or perceptron), support vector machines (e.g., least squares support vector machines), quadratic classifiers, kernel estimation models (e.g., k-nearest neighbor), boosting (meta-algorithm) models, decision trees (e.g., random forests), neural networks, and/or learning vector quantization models. Other types of predictive models can be used.

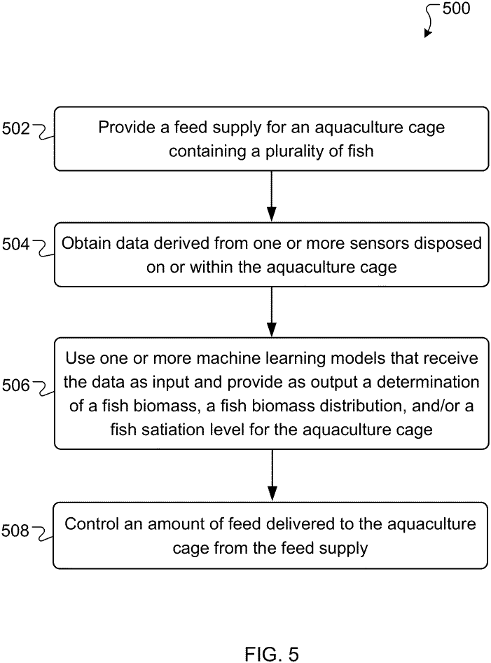

FIG. 5 is a flowchart of a computer-implemented method 500 for biomass detection and feed control in an aquaculture environment, in accordance with certain embodiments. A feed supply is provided (step 502) for an aquaculture cage containing a plurality of fish. Data derived from one or more sensors disposed on or within the aquaculture cage is obtained (step 504). One or more machine learning models are used (step 506) that receive the data as input and provide as output a determination of a fish biomass, a fish biomass distribution, and/or a fish satiation level for the aquaculture cage. Based on the determination from the one or more machine learning models, an amount of feed delivered to the aquaculture cage from the feed supply is controlled (step 508).

### Computer-Based Implementations

In some examples, some or all of the processing described above can be carried out on a personal computing device, on one or more centralized computing devices, or via cloud-based processing by one or more servers. Some types of processing can occur on one device and other types of processing can occur on another device. Some or all of the data described above can be stored on a personal computing device, in data storage hosted on one or more centralized computing devices, and/or via cloud-based storage. Some data can be stored in one location and other data can be stored in another location. In some examples, quantum computing can be used and/or functional programming languages can be used. Electrical memory, such as flash-based memory, can be used.

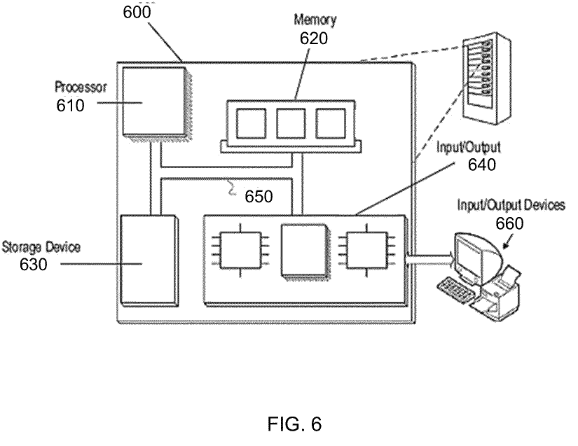

FIG. 6 is a block diagram of an example computer system 600 that may be used in implementing the technology described herein. General-purpose computers, network appliances, mobile devices, or other electronic systems may also include at least portions of the system 600. The system 600 includes a processor 610, a memory 620, a storage device 630, and an input/output device 640. Each of the components 610, 620, 630, and 640 may be interconnected, for example, using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630.

The memory 620 stores information within the system 600. In some implementations, the memory 620 is a non-transitory computer-readable medium. In some implementations, the memory 620 is a volatile memory unit. In some implementations, the memory 620 is a non-volatile memory unit.

The storage device 630 is capable of providing mass storage for the system 600. In some implementations, the storage device 630 is a non-transitory computer-readable medium. In various different implementations, the storage device 630 may include, for example, a hard disk device, an optical disk device, a solid-state drive, a flash drive, or some other large capacity storage device. For example, the storage device may store long-term data (e.g., database data, file system data, etc.). The input/output device 640 provides input/output operations for the system 600. In some implementations, the input/output device 640 may include one or more network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 660. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 630 may be implemented in a distributed way over a network, such as a server farm or a set of widely distributed servers, or may be implemented in a single computing device.

Although an example processing system has been described in FIG. 6, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user’s user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

What is claimed is:

1. A system for biomass detection and feed control in an aquaculture environment, the system comprising:
an aquaculture cage for a plurality of fish;
a feed supply configured to deliver feed to the aquaculture cage;
one or more sensors disposed on or within the aquaculture cage; and
one or more computer processors in communication with the one or more sensors and programmed to perform operations comprising:
obtaining data derived from the one or more sensors; and
using one or more machine learning models to determine, based on the data, for the aquaculture cage, at least one of a fish biomass, a fish biomass distribution, or a fish satiation level; and
based on the at least one of the fish biomass, the fish biomass distribution, or the fish satiation level, controlling an amount of feed delivered to the aquaculture cage from the feed supply.

2. The system of claim 1, wherein the feed supply is located on a supply vessel proximate to the aquaculture cage.

3. The system of claim 1, wherein the one or more sensors include a sensor disposed on a corner of the aquaculture cage, sensors disposed on opposite ends of the aquaculture cage, or a sensor disposed on a wall of the aquaculture cage.

4. The system of claim 1, wherein the one or more sensors comprise at least one of a camera, a proximity sensor, a depth sensor, a scanning sonar sensor, a laser, a light emitting device, a microphone, or a remote sensing device.

5. The system of claim 1, wherein the data comprises one or more of stereo vision data, image data, video data, proximity data, depth data, sound data, or sonar data.

6. The system of claim 1, wherein at least one computer processor from the one or more computer processors is located on a supply vessel proximate to the aquaculture cage.

7. The system of claim 1, wherein the one or more machine learning models are trained to recognize fish poses and to identify images of fish in desired poses, and wherein the one or more machine learning models are configured to output the determination based on at least one of the identified images.

8. The system of claim 1, wherein the one or more machine learning models are trained to determine the fish biomass or the fish biomass distribution based on at least one image of the fish in the aquaculture cage.

9. The system of claim 1, wherein the data further comprises fish behavior data including fish velocity or fish acceleration and the one or more machine learning models are trained to determine the fish satiation level based on the fish behavior data.

10. The system of claim 1, wherein controlling the amount of feed delivered to the aquaculture cage from the feed supply comprises adjusting at least one of a feed rate or a feed frequency.

11. A computer-implemented method for providing a feed supply to an aquaculture cage comprising a plurality of fish, the method comprising:
obtaining data derived from one or more sensors disposed on or within the aquaculture cage;
using one or more machine learning models to determine, based on the data, for the aquaculture cage, at least one of a fish biomass, a fish biomass distribution, or a fish satiation level; and
based on the at least one of the fish biomass, the fish biomass distribution, or the fish satiation level, controlling an amount of feed delivered to the aquaculture cage from the feed supply.

12. The computer-implemented method of claim 11, wherein the feed supply is located on a supply vessel proximate to aquaculture cage.

13. The computer-implemented method of claim 11, wherein the one or more sensors include a sensor disposed on a corner of the aquaculture cage, sensors disposed on opposite ends of the aquaculture cage, or a sensor disposed on a wall of the aquaculture cage.

14. The computer-implemented method of claim 11, wherein the one or more sensors comprise at least one of a camera, a proximity sensor, a depth sensor, a scanning sonar sensor, a laser, a light emitting device, a microphone, or a remote sensing device.

15. The computer-implemented method of claim 11, wherein the data comprises one or more of stereo vision data, image data, video data, proximity data, depth data, sound data, or sonar data.

16. The computer-implemented method of claim 11, wherein at least one computer processor is located on a supply vessel proximate to the aquaculture cage.

17. The computer-implemented method of claim 11, wherein the one or more machine learning models are trained to recognize fish poses and to identify images of fish in desired poses, and wherein the one or more machine learning models are configured to output the determination based on at least one of the identified images.

18. The computer-implemented method of claim 11, wherein the one or more machine learning models are trained to determine the fish biomass or the fish biomass distribution based on at least one image of the fish in the aquaculture cage.

19. The computer-implemented method of claim 11, wherein the data further comprises fish behavior data including fish velocity or fish acceleration and the one or more machine learning models are trained to determine the fish satiation level based on the fish behavior data.

20. The computer-implemented method of claim 11, wherein controlling the amount of feed delivered to the aquaculture cage from the feed supply comprises adjusting at least one of a feed rate or a feed frequency.
